(19) United States
(12) Patent Application Publication
(10) Pub. No.: US 2003/0048842 A1
(43) Pub. Date: Mar. 13, 2003

(54) Method of compressing animation images

(75) Inventors: Xavier Fourquin, Sevres (FR); Christophe Comps, Cestas (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/235,559

(22) Filed: Sep. 6, 2002

(30) Foreign Application Priority Data
Sep. 7, 2001 (FR) 01 11 583

(51) Int. Cl. H04N 7/12

(52) U.S. Cl. 375/240.02; 375/240.08

(57) ABSTRACT

A method of compressing animated images displayed on a screen defined by a frame of pixels, in particular a mobile telephone screen, consists of using a first algorithm for compressing an image in which the percentage of pixels modified relative to the preceding displayed image is greater than or equal to a particular threshold and a second algorithm for compressing an image in which the percentage of pixels modified relative to the preceding displayed image is less than or equal to the threshold.

### BACKGROUND OF THE INVENTION

1. Field of the invention

The present invention relates to a method of compressing animation images.

A preferred application of the present invention is to mobile telephones, but it can be applied in other applications.

2. Description of the Prior art

Multimedia applications of mobile telephones are using and will continue to use more and more animated images of greater or lesser complexity, intended for games, for example, or for messages incorporating symbols.

The formats currently used are defined by the GSM/EMS (Global System for Mobile communications/Enhanced Messaging Service) standard 3GPP TS23.040 v5.00. This specifies the Graphic Interchange Format (GIF).

The WBMP format of the GSM/EMS standard is used for animated or fixed images, which are routinely not compressed. There is provision for data compression/decompression using a single algorithm derived from the LZSS. The algorithm is based on the construction of an “alphabet” of series of data values classified according to the frequency with which they appear in the stream. It is not suitable for compressing and above all for decompressing animations for mobile telephones, because of its complexity and the computation power it requires, and it has therefore not been used.

The Graphic Interchange Format is a compressed image format but its intrinsic aim is not compression of animated images and it necessitates considerable computation power. It is therefore ill suited to mobile telephones.

The object of the invention is to propose an image compression method minimizing the computation power and the memory needed and thereby achieving a good compromise between the low computation power of mobile telephones and the desirable improvement of call bandwidth and transfer time.

This is important for operators, as the transfer of such images occupies call and transfer facilities that are already loaded.

It is also important to users, to optimize their device and also the transfer time, and thus the resulting cost, of downloading applications from the Internet, for example.

### SUMMARY OF THE INVENTION

To this end, the invention consists in a method of compressing animated images displayed on a screen defined by a frame of pixels, in particular a mobile telephone screen, which method consists of using a first algorithm for compressing an image in which the percentage of pixels modified relative to the preceding displayed image is greater than or equal to a particular threshold and a second algorithm for compressing an image in which the percentage of pixels modified relative to the preceding displayed image is less than or equal to the threshold.

In a preferred embodiment the second algorithm defines the positions of the pixels modified between the preceding displayed image and the modified image.

To be more precise the second algorithm codes an image modified relative to a preceding displayed image by storing a list of information pairs in which the first information is the relative position of a modification between the two images and the second information is the modification data item.

The first information is preferably the relative position of the next modified pixel relative to the position of the previous modified pixel and the second information is preferably the value of that position.

Here the value is defined by the colors of the pixels and its blinking, underlined, etc. attributes, depending on whether this value defines them for one or more pixels.

In the preferred embodiment the first algorithm defines identical data sets.

To be more precise the first algorithm codes an image by storing a list of information pairs in which the first information is the length of identical data items and the second information is the data item.

The first information is preferably the number of identical adjacent pixels and the second information is preferably the value of those pixels.

The threshold is advantageously substantially equal to 50%.

The method preferably consists of:

Compressing the first image using the first algorithm;

Analyzing each subsequent image to define the percentage of pixels modified relative to the preceding displayed image;

Comparing this percentage with the threshold; and

Choosing the compression algorithm accordingly.

The invention also provides a method of compressing animated images displayed on a screen defined by a frame of pixels, in particular a mobile telephone screen, which method consists of:

Compressing the first image using a first algorithm;

Compressing subsequent images using the first algorithm and a second algorithm and comparing the performances of the two algorithms; and

Choosing the better performing compression algorithm, the first algorithm defining sets of identical data items and the second algorithm defining the positions of the pixels modified between the preceding displayed image and the modified image.

In a preferred embodiment, the first and second algorithms are those already specified.

The invention also relates to the algorithms for implementing the method.

The method according to the invention of compressing animated images displayed on a screen defined by a frame of pixels consists of using a first algorithm for compressing an image in which the percentage of pixels modified relative to the preceding displayed image is greater than or equal to a particular threshold and a second algorithm for compressing an image in which the percentage of pixels modified relative to the preceding displayed image is less than or equal to the threshold. The threshold is advantageously substantially equal to 50%.

An animation is composed of images that are displayed on the screen one after the other and which can be more or less different from each other in terms of shape, position and size. This modification from one image to the next can be defined by the percentage of pixels modified relative to the preceding displayed image.

Optimum compression presupposes adaptation of the compression algorithm as a function of the above percentage.

To this end, the invention proposes two compression algorithms.

The first algorithm is a compression algorithm that can be described as static: it produces a complete definition of the screen for each image. Hereinafter, it will be given the header code “complete image”.

The second algorithm is a compression algorithm that can be described as dynamic: it produces a relative definition of the image as a function of the preceding displayed image. Hereinafter, it will be given the header code “relative image”.

To be more precise, the first algorithm codes an image by storing a list of information pairs in which the first information is the number of identical adjacent pixels and the second information is the data item, conventionally the value of these pixels.

The second algorithm codes an image modified relative to a preceding displayed image by storing a list of information pairs in which the first information is the relative position of the next modified pixel relative to the previous modified pixel and the second information is the modification data item, conventionally the value of this position.

For the purposes of decompression, the commands of the program contain header data comprising: the algorithm code (compressed “complete image”—first algorithm—or compressed “relative image”—second algorithm), the width and the length of the image.

In the case of the first algorithm, decoding consists of deploying the information pairs.

In the case of the second algorithm, decoding consists of targeting in the preceding displayed image the pixels to be modified and displaying them directly in the memory in which the preceding image is stored.

### DETAILED DESCRIPTION OF THE PREFERRED EMBODIMENT

The following simplified example illustrates the above algorithms.

Consider two images of an animation on a screen with 256 colors and in a screen area of 4×4 pixels, for example.

In uncompressed mode, the lists of attributes are as follows:

Image 1: (4,4) 1,1,1,3,3,0,0,0,0,2,2,127,127,63,63,63

Image 2: (4,4) 1,1,1,2,3,1,0,0,0,0,2,127,127,0,63,63.

This requires a memory space of 2 bytes for the header and 16 bytes for the data for each image, i.e. a total of 36 bytes.

In the compressed state in the “complete image” mode, image 1 is defined by:

(complete image), (4,4)(3,1)(2,3)(4,0(2,2)(2,127)(3,63) i.e. by 15 bytes.

In the compressed state in the “relative image” mode, image 2 is defined by:

(relative image), (4,4)(3,2)(2,1)(4,0)(4,0) i.e. by 11 bytes.

In compressed mode, both images have a size in memory reduced from 36 to 26 bytes, i.e. by 28%.

Within the same program of animation images, the algorithm can be chosen in two ways, empirically or experimentally.

The empirical process is as follows:

Compress the first image using the first algorithm;

Analyze each subsequent image to define the percentage of pixels modified relative to the preceding displayed image;

Compare this percentage with said threshold; and

Choose the compression algorithm accordingly.

The experimental process is as follows:

Compress the first image using the first algorithm;

Compress subsequent images using both algorithms and compare the performances of the algorithms; and

Choose the better performing compression algorithm.

The size of the compressed images varies from one to the other. There are several ways to define the end of the image for the decompression program:

The length of the compressed data is stored in the header; this approach is preferred if all the uncompressed images are the same size;

The length of the decompressed data is stored in the header or is a parameter known to the decompression program; this approach is preferred if the size of the images varies from one to another and is obligatory for completely defined images;

The length and the width of the screen image are stored or are parameters known dynamically by the decompression program. This is the case represented in , the example previously described.

In certain rare and highly specific instances, the compression method can generate more output data than input data when chaining very complex geometrical images. It must therefore be possible to designate uncompressed images; in other words, at any decision level, instead of using the first algorithm or the second algorithm, it may be decided to retain the image as its stands without compression. This situation is not discussed in the above description of the method, as it does not fundamentally modify the subject matter of the invention and how to approach it will be evident to the person skilled in the art.

There is claimed:

1. A method of compressing animated images displayed on a screen defined by a frame of pixels, in particular a mobile telephone screen, which method consists of using a first algorithm for compressing an image in which the percentage of pixels modified relative to the preceding displayed image is greater than or equal to a particular threshold and a second algorithm for compressing an image in which the percentage of pixels modified relative to the preceding displayed image is less than or equal to said threshold.

2. The method claimed in claim 1, wherein said second algorithm defines the positions of the pixels modified between said preceding displayed image and the modified image.

3. The method claimed in claim 2, wherein said second algorithm codes an image modified relative to a preceding displayed image by storing a list of information pairs in which the first information is the relative position of a modification between the two images and the second information is the modification data item.

4. The method claimed in claim 3, wherein said first information is the relative position of the next modified pixel relative to the position of the previous modified pixel and said second information is the value of that position.

5. The method claimed in claim 1, wherein said first algorithm defines identical data sets.

6. The method claimed in claim 5, wherein said first algorithm codes an image by storing a list of information pairs in which the first information is the length of identical data items and the second information is the data item.

7. The method claimed in claim 6, wherein said first information is the number of identical adjacent pixels and said second information is the value of those pixels.

8. The method claimed in claim 1, wherein said threshold is substantially equal to 50%.

9. The method claimed in claim 1, which consists of:
Compressing said first image using said first algorithm;
Analyzing each subsequent image to define the percentage of pixels modified relative to the preceding displayed image;
Comparing this percentage with said threshold; and
Choosing the compression algorithm accordingly.

10. The method of compressing animated images displayed on a screen defined by a frame of pixels, in particular a mobile telephone screen, which method consists of:
Compressing said first image using a first algorithm;
Compressing subsequent images using said first algorithm and a second algorithm and comparing the performances of the two algorithms; and
Choosing the better performing compression algorithm, said first algorithm defining sets of identical data items and said second algorithm defining the positions of the pixels modified between the preceding displayed image and the modified image.

11. The method claimed in claim 10, wherein said second algorithm codes an image modified relative to a preceding displayed image by storing a list of information pairs in which the first information is the relative position of a modification between the two images and the second information is the modification data item.

12. The method claimed in claim 11, wherein said first information is the relative position of the next modified pixel relative to the position of the previous modified pixel and said second information is the value of that position.

13. The method claimed in claim 10, wherein said first algorithm codes an image by storing a list of information pairs in which the first information is the length of identical data items and the second information is the data item.

14. The method claimed in claim 13, wherein said first information is the number of identical adjacent pixels and said second information is the value of those pixels.

15. A device for implementing a method claimed in claim 1, including an algorithm, which device defines the positions of the pixels modified between the preceding displayed image and the modified image.

16. The device claimed in claim 15, which codes an image modified relative to a preceding displayed image by storing a list of information pairs in which the first information is the relative position of a modification between the two images and the second information is the modification data item.

17. The device claimed in claim 16, wherein said first information is the relative position of the next modified pixel relative to the position of the previous modified pixel and said second information is the value of that position.

18. The device for implementing a method claimed in claim 1, including an algorithm, which device defines identical data sets.

19. The device claimed in claim 18, which codes an image by storing a list of information pairs in which the first information is the length of identical data items and the second information is the data item.

20. The device claimed in claim 19, wherein said first information is the number of identical adjacent pixels and said second information is the value of those pixels.
